(19) United States
(12) Patent Application Publication
(10) Pub. No.: US 2018/0097845 A1
(43) Pub. Date: Apr. 5, 2018

(54) Self-Managed Intelligent Network Devices that Protect and Monitor a Distributed Network

(71) Applicant: Rapid Focus Security, LLC, Burlington, VT (US)

(72) Inventors: Rong Chen, Boston, MA (US); Sam Stelfox, Burlington, VT (US)

(73) Assignee: Rapid Focus Security, LLC, Burlington, VT (US)

(21) Appl. No.: 15/285,733

(22) Filed: Oct. 5, 2016

(51) Int. Cl. H04L 29/06; H04L 29/08; H04L 12/26; H04L 12/24

(52) U.S. Cl. CPC H04L 63/20; H04L 67/1042; H04L 63/1425; H04L 41/12; H04L 63/0272; H04L 43/065

(57) ABSTRACT

A method of managing devices that monitor and protect a distributed network includes obtaining a peer topology and master-selection rules at each of a plurality of peer devices. A master device at each of the plurality of peer devices is selected using the peer topology and master-selection rules. Device management information and operation information is received at the master. Updated master-selection rules and updated peer topology is obtained. The master sends to each of the plurality of peer devices tasking and task updates. The plurality of peer device reports is generated based on the tasking and is received at the master. A master report is generated based on the plurality of reports. A new master device is selected from the plurality of peer devices based on a determination of whether the master device is disconnected.

The section headings used herein are for organizational purposes only and should not be construed as limiting the subject matter described in the present application in any way.

### INTRODUCTION

The growing number of wireless and wired network devices worldwide has generated a need for methods and apparatus that find and manage both trusted and untrusted devices quickly and efficiently. These trusted and untrusted devices include network nodes and processing devices. Networks of trusted devices, which can be located and operate across various combinations of private and public networks, can be managed and instructed by a trusted server, or a set of trusted servers, in order to perform a variety of coordinated and distributed tasks. One of many important tasks conducted by these distributed networks of trusted devices is the detection, review, and identification of rogue, misconfigured, and unauthorized devices across wired and wireless spectrums that are used by the various trusted and untrusted devices on the various networks. Other tasks include the enforcement of “bring your own device” policies for a corporate enterprise network, network penetration testing, network threat detection, and investigation, audit, and compliance.

Ease of operation and reduced cost is possible when the position identification of the trusted nodes is fully automated to simplify and increase the efficiency of network operations and task management. Automatic detection of the location of a device, and its association with a particular customer and/or client owner, provides the potential for fully automatic configuration of devices. Autonomous connection and configuration minimizes the work involved for any installer placing remote devices, or sensor nodes. This also minimizes possible errors that can occur.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a network instantiation of an embodiment of an apparatus and method for managing devices that monitor and protect a distributed network of the present teaching.

FIG. 2 illustrates a process flow diagram of an embodiment of an apparatus and method of managing devices that monitor and protect a distributed network of the present teaching.

FIG. 3 illustrates a sequence diagram of an embodiment of an apparatus and method of managing devices that monitor and protect a distributed network of the present teaching.

FIG. 4A illustrates an all-way connected cluster of six peer devices located on multiple target networks of an embodiment of an apparatus and method of managing devices that monitor and protect a distributed network of the present teaching.

FIG. 4B illustrates a virtual ring topology determined by a remote management node of an embodiment of an apparatus and method of managing devices that monitor and protect a distributed network of the present teaching.

FIG. 5 illustrates a software and hardware module block diagram of a security appliance of an embodiment of an apparatus and method of managing devices that monitor and protect a distributed network of the present teaching.

FIG. 6 illustrates an ecosystem of services of an embodiment of an apparatus and method of managing devices that monitor and protect a distributed network of the present teaching.

FIG. 7 illustrates a block diagram of hardware and software modules of an embodiment of the apparatus and method of managing devices that monitor and protect a distributed network of the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

In some methods and apparatus according to the present teaching, a family of remote devices is deployed across a distributed network to autonomously discover each other and set up a device management capability in order to perform collective tasks, such as monitoring and securing the network or networks in which the devices are deployed. The devices are all participating in similar tasks, and are characterized by stealthiness and/or unobtrusiveness. For example, the devices may provide silent proactive threat scanning or network performance monitoring of the network domains in which they are located. The devices all communicate back to a management node that is commonly located outside of the network domains in which the devices are located. The hardware that is acting as the management node can take several forms. For example, the management node may be a central server or a load-balanced hosted solution.

The devices send network health information, potential intrusions and other information to the management node. The devices also receive management and upgrade instructions from the management node, including operational tasks that they are to perform, changes to monitoring policies, updates to a set of signatures they use to detect attacks, updates to the frequency of scan and range of target scan, and also binary upgrade of the libraries.

One embodiment of the present teaching provides an apparatus and method for managing the devices such that the messaging between the devices and the management node are reduced. This reduced amount of management- and operation-related communications between the devices and the management node allows the devices to operate in an unobtrusive and/or stealth manner.

In some known distributed remote device management systems, each device communicates directly with the management node, typically using the Internet or wide area network (WAN) connection. This management communication configuration generates excessive network traffic, leads to suboptimal repetitive processing in the management node, and also leads to significant loss of unobtrusiveness. This communication configuration also means that the subversive agents and programs running on the devices are more likely to be detected because of the high volume of repetitive traffic flowing between the devices and the management node. Isolated devices communicating directly with the management node is inefficient for any system with a large number of devices operating. Isolated devices that are not self-managed and/or do not communicate and organize a management structure with peer devices are prone to scan the same network multiple times. This results in the same information being accumulated. This information is redundant and thus, does not contribute to the integrity of the monitoring task. Rather, the collection and transmission of this redundant information causes excessive and unnecessary load. The collection and transmission of the redundant information can also cause conflicts. Conflicts can occur in transmission and also in processing of data as a result of the redundant unnecessary data being transmitted and processed.

The larger the number of devices deployed at the target network or networks, the larger the problem of redundant and unnecessary data becomes in prior art systems with devices operating in isolation from each other. As such, peer-aware, self-managed devices of the present teaching are better able to handle large scale deployments. Peer-aware devices are much more efficient. They can compliment each other in performing various tasks. Peer-aware devices can, for example, split up scan regions so as to assign particular regions to particular devices based on their location, load, and other factors. They can adapt to conditions over time, and change assignments based on local conditions. As a result, the self-managed intelligent network devices that protect and monitor a distributed network of the present teaching are well suited to large scale network deployments.

One aspect of the present teaching is the realization of the need for network security and monitoring solutions that rely on one or more distributed, non-obtrusive devices that are autonomously managed and are updated without individual devices connecting to a central server or remote management node. In addition, software updates on distributed, non-obtrusive devices must occur without individual devices reaching out across the network domain they are scanning and/or monitoring to communicate with the management node.

Many known distributed device management systems suffer from systemic inefficiency and are unable to perform unobtrusive network health, performance and security monitoring because of the pattern of communications and because of the volume of communications between the distributed devices and the management node. In the case of network performance monitoring, the cumulative effect of a large cluster of devices all communicating to a central management node can trigger monitor alerts and thereby render the performance monitoring solution itself as a source of poor performance. This negates the business value of such a solution, at least in part, because known management systems for distributed clusters of devices duplicate tasks and services. The devices of prior art management systems do not self-manage and lack awareness of other peer devices.

Known network monitoring and network scan tools typically err on the side of redundancy, duplication and repetition in order to avoid missing out on alerts and intrusions. The redundancy is typically kept in check by compartmentalizing, a priori, the scan/monitoring domains. However compartmentalizing leads to inefficiencies and, more importantly, inflexibilities due to lack of abilities to expand the target domain dynamically. What is needed, therefore, are systems of distributed devices that can self-organize within and across network domains to provide a single coordination point for management and operations that effectively reduces the required communications for performing collective tasks.

Self-management of distributed devices for performing collective tasks is most efficient when one of the peer devices acts as a master. The master takes on an orchestration role for the distributed set of peer devices. To eliminate a single point of failure, the master role may be transitory, in that various peer devices may be the master for particular spans of time. For example, if a master is disconnected from the distributed peer group, a new master can take over.

In distributed systems, a master election is the process of designating a single device as the organizer of some task or set of tasks distributed among several devices. Before the tasking begins, all devices are either unaware which device will serve as the master of the task, or unable to communicate with the current master. After a master election algorithm is processed, however, each device throughout the network recognizes a particular, unique device as the master.

The devices communicate among themselves in order to decide which of them will assume the master state. Determining the master requires a method to break the symmetry among devices and establish a consensus rank of the various devices. For example, if all devices have unique and comparable identities that can be ranked, then devices can compare their identities and decide that the device with the highest ranked identity is the master. It is desirable for master election algorithms to be economical in terms of total bytes transmitted and processing time.

Some methods and apparatus of the present teaching utilize various algorithms for master selection in the distributed system of peer devices. Some particular embodiments utilize classical machine learning algorithms such as regression algorithms. Other particular embodiments utilize meta-heuristic approaches such as generic programming. Using a master device selected from amongst the peer devices increases operational inefficiency for distributed systems that perform network monitoring and threat detection in a substantially unobtrusive manner. Many known security and monitoring systems do not use self-management apparatus and methods.

Some methods and apparatus according to the present teaching manage devices that monitor and protect a distributed network managing a distributed set of trusted devices that perform collective tasks. The tasks include monitoring the distributed network to detect and identify other rogue, misconfigured and unauthorized devices attached to that distributed network. The apparatus and method can provide real-time monitoring and threat detection for all the wireless and wired devices connected to the distributed network. The apparatus and method can also identify, fingerprint, and monitor rogue, misconfigured and unauthorized devices attached to the distributed network. The apparatus and method can also perform vulnerability assessment of the distributed network and attached devices.

Persons skilled in the art will appreciate that various aspects of the apparatus and method of managing devices that monitor and protect a distributed network of the present teaching can also be applied to self-management of devices distributed in a network performing a variety of collective tasks. For example, collective tasks can include performing content delivery, sensing, big-data analysis, distributed control, autonomous vehicle control, and many other tasks. As such, the description of the various elements and steps of the apparatus and method of the present teaching in the context of performing a task of monitoring and protecting a network should not be construed as limiting the subject matter specifically described herein.

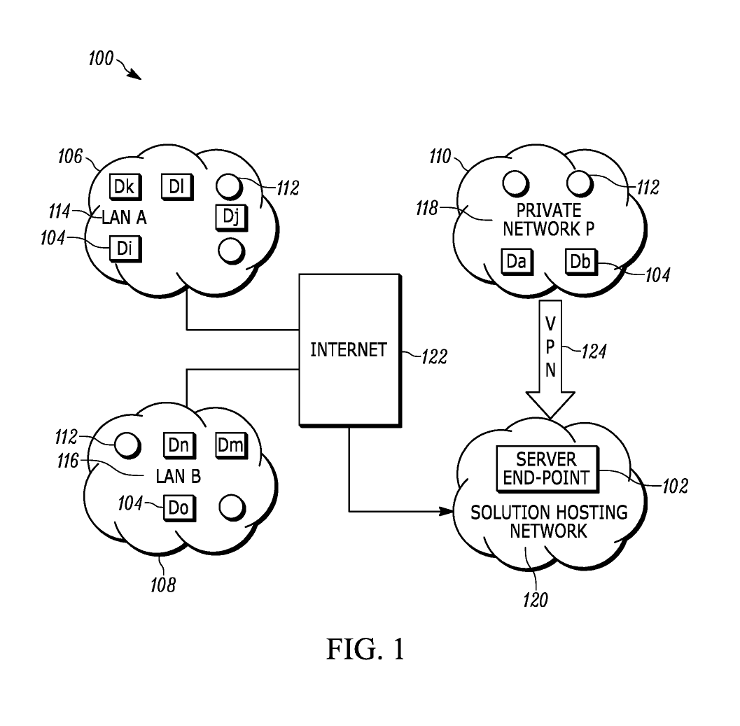

FIG. 1 illustrates an embodiment of an instantiation of a network 100 of the present teaching. The network 100 comprises an endpoint server 102 connected to one or more trusted devices 104 that are deployed in various network domains 106, 108, and 110. The endpoint server 102 functions as a remote management node. The remote management node may also be called a remote management server, an endpoint server, a server or a remote management platform. The various network domains 106, 108, and 110 also comprise various untrusted devices 112, shown as circles in FIG. 1. In the embodiment of FIG. 1, the various network domains 106, 108, and 110 with trusted network devices 104 and untrusted network devices 112 include two local area networks, LAN A 114 (in domain 106), and LAN B 116 (in domain 108), and private network P 118 (in domain 110). The endpoint server 102 is located in solution hosting network segment H 120.

While the network configuration shown in FIG. 1 illustrates that the endpoint server 102 is a single device, it is well-known that the endpoint server's function can also be performed by a distributed network of servers. The endpoint server 102 can be located at a secure offsite location. The endpoint server 102 can also be located at any remote location, including a cloud. The terms “cloud”, and “cloud networking” as used herein includes services and networks that run over the public internet and work over any physical communications infrastructure, including wired or wireless infrastructures. The term “cloud” as used herein also includes so-called “private clouds” networking and services that run similarly over a private or proprietary infrastructure. The endpoint server 102 can also be located at one of the onsite networks where one or more trusted network devices 112 reside.

In the embodiment illustrated in FIG. 1, LAN A 114 and LAN B 116 are connected to the host network H 120 via the Internet 122. The private network P 118 is connected to the host network H 120 via a virtual private network VPN tunnel 124. The connections of the trusted devices 104 to their various network domains 106, 108, and 110 can be a wired connection, a wireless connection, or a combination thereof. One skilled in the art will appreciate that there are many variations of the network configuration shown in FIG. 1. In various embodiments, the trusted devices 104 are located in any variety of known network domain types that are connected to the host network H 120 via any variety of network connections, including public and private connections, secure and unsecure connections, and/or overt and covert connections.

It should be understood that the trusted devices 104 described herein can be also be referred as nodes, clients, and/or sensors. The trusted devices 104 may be part of the existing network infrastructure of the network in which they are located, or they may be placed, overtly or covertly, inside the network by an installer. In some embodiments, the trusted devices 104 are existing network devices that install new software code that runs protocols that implement the method of managing devices that monitor and protect a distributed network according to the present teaching. In some embodiments the trusted devices 104 are unobtrusive “drop-in” devices that perform network scan and monitoring in a hardware-agnostic manner.

The trusted devices 104 may include any of a variety of networked devices including network nodes, such as switches and routers, wireless routers, computer processors, and storage devices. These trusted devices can be in client devices or server devices. These trusted devices take the form of tablets, laptops, and other specialized computing devices, such as gaming devices. These trusted devices can also take the form of video servers and security appliances. In addition, these trusted devices can take the form of communication devices, such as cell phones and smart phones.

In one specific embodiment, the trusted devices are constructed in small-form-factor pluggable devices that are designed to be placed covertly on a local network. The trusted device can be unpingable with no listening ports. Thus, in one embodiment, the trusted device operates in a stealth mode.

The trusted devices can perform one or more of several functions, such as one-click Evil AP and Passive Recon services, persistent reverse-SSH access to the target network, six unique covert channels for remote access through application-aware firewalls and IPS, support for HTTP proxies, SSH-VPN, and OpenVPN, out-of-band SSH access over 4G/GSM cell networks, and wired NAC/802.1x/RADIUS bypass capability. The trusted devices can also provide local console access via HDMI.

In some embodiments, the trusted devices 104 are smart phones that include an external high-gain 802.11b/g/n wireless supporting packet injection & monitor mode. Also, in some embodiments, the trusted devices 104 are smart phones that include an external high-gain Bluetooth supporting packet injection (up to 1000′). Also, in some embodiments, the trusted devices 104 include an external USB-Ethernet adapter for wired network penetration testing. The smart phones may provide a custom Android front-end with penetration testing apps, such as Evil AP, Strings Watch, Full-Packet Capture, Bluetooth Scan, and SSL Strip. The smart phones may also utilize a custom Kali Linux back-end with comprehensive penetration testing suite, such as Metasploit, SET, Kismet, Aircrack-NG, SSLstrip, Ettercap-NG, Bluelog, Wifite, Reaver, MDK3, and FreeRADIUS-WPE. Also, the smart phones may provide one-touch update for a software toolkit. Also, the smart phones may provide multiple different covert channels to tunnel through application-aware firewalls & IPS. In addition, the smart phones may be unlocked 4G/LTE GSM (SIM card not included) and include USB OTG cable (for USB host-mode).

The trusted devices 104 may utilize wireless or wired connections to their respective local network infrastructure, LAN A 114, LAN B 116 or private network P 118. In some embodiments, a trusted device 104 of the system can connect to the Internet 122 via an Ethernet connection to the target network. In other embodiments, a trusted device 104 is capable of connecting to the Internet 122 via a wireless adapter connected to the device. In addition, the trusted device 104 can be capable of connecting to the Internet 122 via a cellular network adapter connected to the device. For example, the trusted device 104 can establish out-of-band SSH access over the cellular network.

It should also be understood that the network domains described herein are groups of connected devices on a network that are administered as a unit. The administration may be for purposes of management and/or security. Within the Internet, domains are defined by the IP address. All devices sharing a common part of the IP address are within the same domain. It is well known in the art that other network attributes, including various device identification means, may also be used to define a particular network domain. A network domain boundary may also be defined by one or more firewalls that restrict access to the domain. Once a domain boundary is defined, by whatever means and, for whatever purpose, the method of the present teaching provides a way to determine the domain in which a particular device is located, and more particularly, whether two devices are located within the same domain. The term network segment may also be used to represent a set of devices that belong to the same group or domain.

A single master is selected from amongst the peer devices using known mechanisms for leader election in distributed systems. In some embodiments, the mechanism to select the master can be heuristically improved and is shared across all the peers. Once selected, the master device communicates with the remote management node. In some embodiments, all the peers connect to the remote management node to share information that seeds the selection process. In these embodiments, once the master is selected, the communication pattern to the remote management node changes from all the devices connecting to the remote management node to only the master connected to the management node. In some embodiments, all the peers autonomously bootstrap discover each other to share information that seeds the selection process. In these embodiments, the only communication to the remote management node is from the selected master after the master selection process.

The master device obtains task list, configuration changes, management operations list and upgrade details from the remote central management node. The master device coordinates the distribution of the tasks, operational information, management information, updates and upgrades, to the relevant peer devices. In case that the master device becomes disconnected from remote management node, the master device caches all the data and reports collected from the peer devices, so they can be sent back to the remote management node when the master device is reconnected to the remote management node.

In addition to coordinating tasks between the other devices, the master device also ensures that the entire set of peer devices have full transparency into the algorithms and configurations used by the master device. The master device transmits any changes to all the peer devices in near-real time. This near-real-time updating of the peer devices ensures that when the active master device becomes disconnected from the cluster of peer devices, the cluster of peer devices can perform another selection process to select another master. The mechanism used to elect a master may be improved through self-learning, such that all the peers are in possession of the same set of rules and considerations for each round of master selection process.

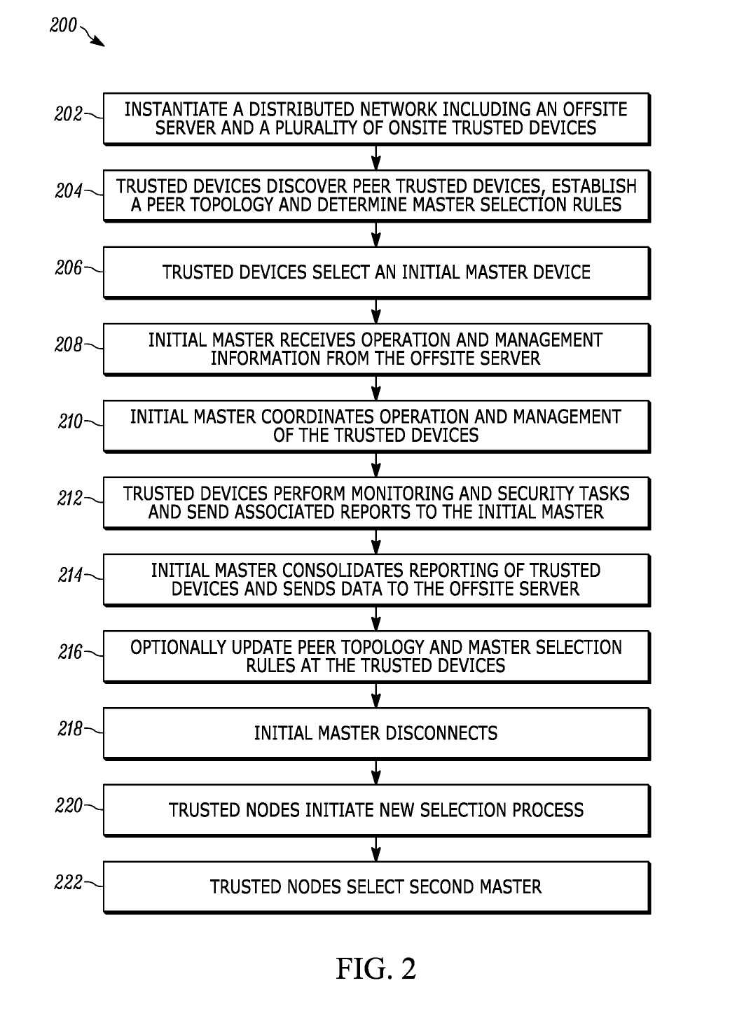

FIG. 2 illustrates a process flow diagram 200 of an embodiment of a method of managing devices that monitor and protect a distributed network of the present teaching. Step one 202 of the method 200 instantiates a distributed network that includes a plurality of peer devices and a server acting as a remote management node. In some embodiments, the peer devices are in one or more network domains onsite at a target network. In some embodiments, the server is located offsite. In some embodiments, the peer devices are trusted devices. In step two 204 of the method 200, the peer devices discover each other and establish a peer topology and master selection rules. In some embodiments, the discovery process includes steps of hand-shake and authentication. In these embodiments, devices exchange certificate information. Only devices with authenticated certificates communicate. In some embodiments of the discover step, each device scans the network and authenticates found devices with certificates.

In some embodiments the master selection rules comprise a priority schema or rank order assignment for each of the peer devices. The plurality of peers are located and identified to each of the other peers in one or more network domains onsite at a target network from a universe of devices scattered in one or more network domains onsite at a target network in a non-obtrusive manner. In some embodiments, the master selection rules comprise determining the peer device that has been online for the longest period of time. By online, we mean connected to the target network. In embodiments where the master selection rules comprise determining the peer device that has been online for the longest period of time, the peer devices determine how long each device has been online at the time they are authenticating each device. Thus, each peer device will have stored the online time of every other peer device that has been authenticated, and each peer device will select as the master node the peer device with the longest online time. The master node may also pass the stored online time of all the devices to the remote management node.

Various known methods of peer device location and identification may be used. For example, see U.S. patent application Ser. No. 15/265,368, filed on Sep. 14, 2016. Alternatively, or in addition, pre-configuration, full discovery, and/or any of a variety of Internet protocols and/or wireless device discovery protocols may be utilized. Once the peers in one or more network domains onsite at a target network have been identified, an efficient topology for effective and optimized communication amongst the peer devices to support master election is established. The devices also obtain master selection rules. The master selection rules may be pre-configured and pre-established in the devices and stored in memory. The master selection rules may also be sent to the peer devices during a set-up phase. In some methods according to the present teaching, the master selection rules may also be heuristically improved over iterations and periodically updated.

In step three 206 of the method 200, the peer devices select an initial master device. The peer devices use the peer topology and master-selection rules to perform the selection process. Those skilled in the art will recognize that various known methods of master selection, also referred to as leader election, may be used. Master selection algorithms are known to converge to the following state: 1) eventually there is a master selected, and 2) never more than one master is selected at a time. The use of a master selection algorithm provides flexibility for the management of the distributed peer devices. If a master device is disconnected or fails in some way, the peer devices can advantageously elect another master and continue their collective tasks. Thus, the coordination task is no longer subject to a single point of device failure. The use of a master selection algorithm to select a master in the present teaching advantageously allows a single device to handle coordination of the tasks and updates of the peer devices. This feature results in far less communication to a remote management node than prior art systems that do not select a master device to coordinate the collective tasks being performed by the peer devices.

In step four 208 of the method 200, the initial master receives management information and operation information from a remote management node. In some embodiments the remote management node is an offsite server. In some embodiments the management information and operation information includes one or more of a task list, configuration changes for the peer devices, management operations list, and upgrade details for the peer devices. In some embodiments, the tasking comprises one or more of monitoring the distributed network, detecting attacks on the distributed network, identifying rogue devices in the distributed network, simulating an attack on the distributed network, performing penetration testing on the distributed network. In some embodiments, the upgrades comprise a binary library upgrade. Also, in some embodiments, task updates comprise one or more of an attack signature, a target of a scan and a frequency of a scan.

In step five 210 of the method 200, the initial master coordinates operation and management of the peer devices. In step six 212 of the method 200, the peer devices perform monitoring and security tasks. Some of the monitoring and security tasks can generate data related to information about various other devices on the network. This includes identification of security vulnerabilities, identification of rogue or misconfigured devices, and identification of anomalous or otherwise suspicious devices or device behavior. The data is assembled into reports by the various peer devices, and the reports are sent back to the initial master.

In step seven 214 of the method 200, the initial master consolidates the reports into a master report and sends them to the remote management node. The initial master may also provide peer device configuration information to the remote management node in a configuration report. The peer device configuration information may be used by the remote management node to improve the peer device topology and master selection rules. The master is responsible for pushing data to the remote management node.

In some embodiments, the master does not perform any of the scanning, monitoring or security tasks. The only job of the master is to coordinate and manage the peer devices. The master optimizes the tasking requested by the remote management node across the various peer devices in multiple ways. For example, the master may assign tasking such that the load on the devices is even. Tasking may be assigned to carefully manage the traffic flow across the network. Tasking may be assigned to speed the delivery of the particular task throughout the network. Tasking may also be assigned to target particular known trouble spots of the target network. Tasking may also be assigned to maximize coverage of the target network. In addition, the master may assign tasks such that a series of smaller tasks are performed in a short amount of time. The smaller tasks may generate small data sets that can be communicated more quickly. These short duration, frequent task assignments allow the master to push data to the remote management node more quickly. In these embodiments, the data is provided to the remote management node in near real time.

One feature of the present teaching is it allows the use of heuristics to establish the master selection rules and also the peer topology. In embodiments when one or more of the master selection rules or peer topology are established using heuristic methods, the topology and selection rules may be occasionally updated during successive iterations of the steps of the method 200. In step eight 216 of the method 200, the master device optionally sends updates to the peer topology and/or the master selection rules to the peer devices. In some embodiments, the master device determines the updates and sends them to the peer devices. Also, in some embodiments, the remote management node determines the updates and sends them to the master and the master sends them to the peer devices.

One feature of the methods and apparatus of the present teaching is that it allows the various peer devices to come and go from the distributed network yet the collective monitoring and security tasks remain operational. Thus, in step nine 218 of the method 200, the initial master is disconnected, or otherwise fails. The peer devices recognize that the initial master is disconnected and initiate a new master selection process in step ten 220 of the method 200. In step eleven 222 of the method 200, a second master is selected using the current master selection rules and peer topology information residing in the peer devices. The second master device communicates with the remote management node and assumes the activities previously performed by the initial master. In some embodiments, the second master device is the second longest online time device as based on the previously stored online time of all the devices that is resident in all the devices. In these embodiments, when the second master is selected, the initial master is also removed from the memory of the peer devices.

Non-master peer device may become disconnected or otherwise unavailable. In some embodiments, when a non-master peer device becomes unavailable, the tasks assignments are redistributed to cover the gap.

It will be understood by those skilled in the art how improvements in the master selection rules and peer topology may be determined and communicated during successive iterations of steps of the methods of the present teaching. Thus, the method of the present teaching affords increasing efficiency of operation over time, as the selection process becomes more efficient. In some embodiments, this efficiency is manifest by reduced communications required amongst the peer devices and also between the master and the remote management node.

In some embodiments, the server determines a peer device location for each of the peer devices. Then the server determines a priority schema using the determined peer device locations and generates a peer topology using the priority schema. The server then generates master-selection rules based on the peer device topology. In some embodiments the generated peer topology is heuristically improved by iterating through the steps of determining the device location, determining the priority schema, and generating the topology.

One aspect of the present teaching is that the methods and apparatus described herein can reduce the need for redundant communications between the devices performing the collective monitoring and security tasks in the network and the remote management node as compared to known systems. Through various discovery means, the devices are aware of all similar devices that are able to communicate. The devices communicate with each other and select a single device as master. Then only the master communicates with the devices to perform the management task and coordinate the monitoring and security effort. This eliminates the need for each device to maintain an active and open communication with the remote management node.

Once selected, the master device is also the sole device to push data to remote management node. Upon receiving the initial data and subsequent data, the master will determine what the tasks are and what services the devices will provide. The master can also send any learning algorithms and coordination rules to the devices in real time. In addition, the master can determine the software version updates and coordinate software version updates. The master will store the update instead of leaving each individual device to perform its own update. In some embodiments, devices operate independently as isolated unit. In these embodiments, there is no coordination among the devices.

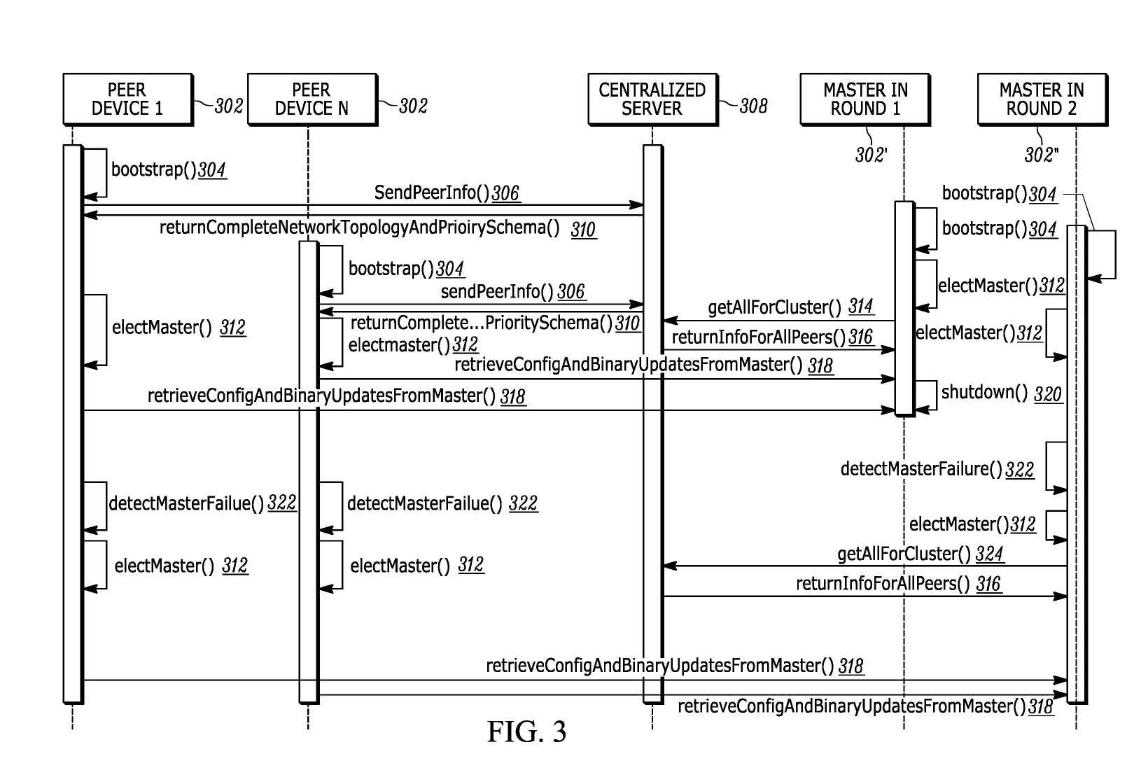

FIG. 3 illustrates a sequence diagram of an embodiment of an apparatus and method of managing devices that monitor and protect a distributed network of the present teaching. Each of a plurality of peer devices 302, 302′, and 302″ performs a bootstrap function 304 that autostarts and initializes the peer devices. The devices 302, 302′, and 302″ then send peer information 306 to a centralized server 308. In some embodiments the peer devices 302, 302′, and 302″ are located onsite at a target network. In some embodiments, the centralized server 308 is a remote management node that is located offsite. The centralized server 308 returns network topology information and a priority schema 310 to the peer devices 302, 302′, and 302″.

Each peer device 302, 302′, and 302″ executes the elect master algorithm 312. One peer device 302′ becomes the elected master for round one and performs a getAll for cluster request 314 from the centralized server 308. The getAll command requests information the server has about the peer devices 302, 302′, and 302″. The centralized server 308 executes a return command 316 and returns the information it has about all the peer devices to the peer device 302′ elected master in round one. The peer devices 302, 302′, and 302″ execute retrieve commands 318 to obtain configuration and binary updates from the master in round one 302′.

The peer device 302′ elected master in round one goes into a shutdown 320. Each of the peer devices 302, 302′, and 302″ detect 322 the master failure. Each peer device 302, 302′, and 302″ executes the elect master algorithm 312. This results in a peer device 302″ becoming master in round two. The peer device 302″ elected master in round two then performs a getAll for cluster request 314 from the centralized server 308 which requests information the centralized server 308 has about the peer devices 302, 302′, and 302″. The centralized server 308 executes a return command 316 and returns the information it has about all the peer devices to the peer device 302″ elected master in round two. The peer devices 302, 302′, and 302″ execute retrieve commands 318 to obtain configuration and binary updates from the master in round one 302′.

One feature of the present teaching is that the self-management process is optimized and efficient for a given cluster of peer devices 302, 302′, and 302″ when the communication between the peer devices are minimized as well as when communication from the cluster of peer devices 302, 302′, and 302″ to the centralized server 308 is minimized. Minimizing communication from the cluster of peer devices 302, 302′, and 302″ to the centralized server arises because a single master is selected from the cluster, and the master device is the only one to reach out to the centralized server 308. Thus, the master device proxies for all the peers in the cluster and subsequently retrieves configuration and binary updates for all peer devices in the cluster, and sends data obtained from all devices to the central server 308. The master also ensures that each peer device is aware of the algorithms and parameters being used to constantly create an optimized local graph for the inter-peer-device communication. This is important because the “master” designation is transient, and the cluster of peer devices must immediately reconfigure to choose a new master when the current master becomes stressed or unavailable for any reason.

In some embodiments, the process of selecting a master device from the cluster of peer devices involves selecting a peer topology for the peer devices and accordingly applying various leader election algorithms to select the master. The leader election algorithm may be any of a number of known leader election algorithms. The leader election algorithms may be deterministic algorithms, probabilistic algorithms, heuristic algorithms, self-evolving algorithms or any combination thereof.

A structure in which all the peer devices are connected to one another is known as a complete network. In some embodiments, a deterministic leader election algorithm is used on a complete network. Bootstrapping is performed at a first communicate-to-server stage where each peer device connects to the server and each peer is seeded back information about all the other peers. In a peer device cluster of n nodes, there exists an efficient master election algorithm with only O(n) messages in O(n) time, where O(n) is “big 0” notation that indicates an algorithm classified to scale of order n as the number of nodes, n, grows.

Details of example leader election algorithms are described in, for example, J. Villadangos, A. Cordoba, F. Farina and M. Prieto, “Efficient leader election in complete networks,” 13th Euromicro Conference on Parallel, Distributed and Network-Based Processing, 2005, pp. 136-143. The algorithm succeeds by creating virtual rings of simultaneously active nodes using a priority schema. By using the term “active”, we mean the nodes that participate in the algorithm. In some embodiments, the server seeds the process by establishing a priority rank for the nodes before the leader election algorithm is executed. The centralized server 308 can then continue to use new routing information obtained from each of the devices to fine-tune the priority schema for subsequent master elections.

The centralized server 308, acting as a remote management node, determines the location in one or more network domains of each of the peer devices in the cluster. Various known location identification methods may be used. Because the server has a complete map of the peer devices in the cluster, the centralized server 308 can also seed the devices with a priority schema once it has determined an efficient topology and priority schema to execute the leader election algorithm.

In some embodiments, the centralized server 308 determines a topology and priority schema that is a particular distribution of virtual rings. The priority schema can be built on a heuristic that groups the peer devices according to proximity with each other. Proximity distance is computed by the server for each peer device based on the number of hops from the edge of the network to the peer device. Using the proximity distance, the centralized server 308 constructs Bayesian k-means sub-clusters where each such sub-cluster now belongs to a different proximity zone and hence is assigned different priorities in the priority schema and placed in a virtual ring topology.

In a complete network, an O(n) leader election is realized by assigning the nodes to virtual rings and assigning a priority schema, or rank for each node in the ring. Peer devices become aware of the rank of their neighbors in the ring, and then higher priority devices ask lower priority devices about their predecessors. Once a lower priority device has communicated with a higher priority device, the lower priority device drops out. Once the highest priority device confirms that all the other devices have dropped, it knows it is the master.

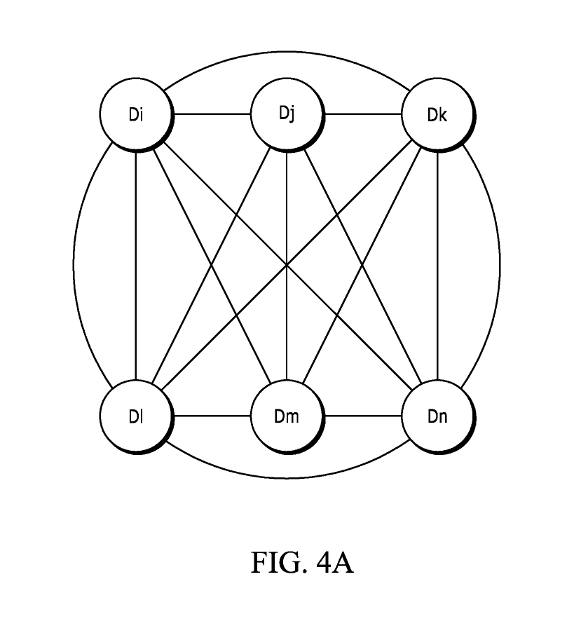

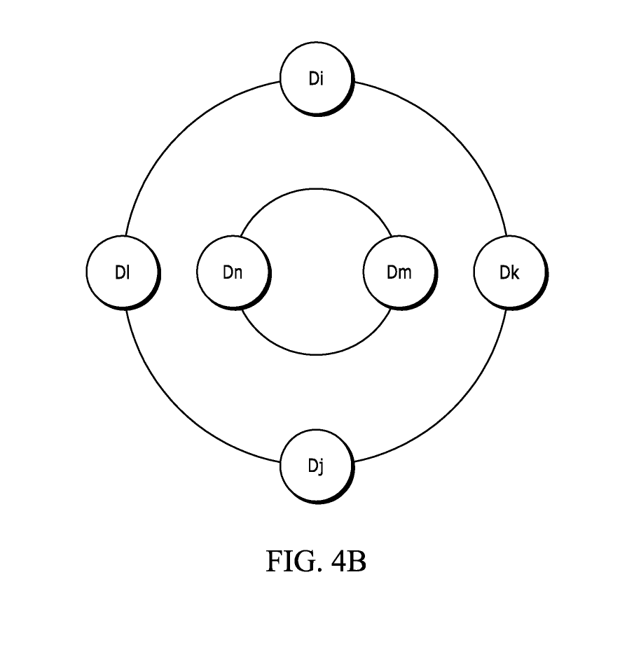

FIG. 4A illustrates an all-ways connected cluster of six peer devices located on multiple target networks. This is an example of the step of determining a topology and priority schema of the present teaching. The devices are connected to each other and also connected to a remote endpoint server (not shown). Referring to both FIG. 1 and FIG. 4A, server endpoint 102 determines that trusted devices 104 Dᵢ, Dⱼ, Dₖ, and Dₗ are located in the same domain 106. The server endpoint 102 determines that trusted devices 104 Dₙ, Dₘ are located in the same domain 108. The endpoint server 102 then computes two virtual rings and a priority schema for the six peer devices Dᵢ, Dⱼ, Dₖ, Dₗ, Dₙ, and Dₘ. The virtual rings and a priority schema are determined by the endpoint server 102 based on the known proximity distance of each of the peer devices. FIG. 4B illustrates the virtual ring topology determined by the endpoint server 102.

One skilled in the art will appreciate that the above description of leader election using virtual rings is just one particular example. In various other embodiments, other topologies and priority schema are used that will result in an efficient leader election algorithm based on the location of the peer device in the cluster. In some embodiments, the server does not seed the topology and priority schema. The seeding is either established in the peer devices prior to deployment, or established collectively by the peer devices upon a bootstrap discovery process being run by the peer devices in the target network.

Once a master is elected, all peers communicate only to the master and the master communicates to the server. That is, subsequent to the master election all communications are O(n). However, having a single master creates a single point of failure. In order to make the system fully resilient against the master being stressed or busy, the entire cluster can be configured to re-elect a new master under such conditions.

In some embodiments, the topology and the proximity measures for each of the peer devices are made available to each of the peers. In these embodiments, the peers can use this information to establish their own virtual rings and priority schema. When subsequently a peer detects a master communication failure, the peer automatically assumes that all other peers will detect the same and initiates the master election mechanism. The master election mechanism involves generating a new priority schema to construct the virtual rings and this priority schema typically differs from the one used previously because now the sub-clustering according to proximity is disrupted because of the absence of a previously active peer. Each device now re-computes the proximity sub-clusters and self assign its own priority to create the virtual rings for master election.

As will be appreciated by those of skill in the art, additional layers of master hierarchy may be employed in the method of managing devices that monitor and protect a distributed network of the present teaching. Using additional layers of master devices allows the system to scale to even larger deployments. In some embodiments, certain devices are used to perform restoration and recovery functions. These devices may maintain and process reference information about the peer devices to aide recovery. The hierarchy of master devices in these embodiments can also perform distributed management of tasking and pushing data to the remote management node, reducing network traffic. The hierarchy of master devices are able to pass status and health information more frequently and more precisely than prior art systems. Each master in a hierarchy of master devices may perform a particular analytic function and/or reporting task. This helps to improve the load on a given master device, and also improve the voracity of the processed information.

Some embodiments of the present teaching do not rely on Bayesian k-means clustering for the proximity-driven-priority computation of topology and priority schema. In various other embodiments, various known techniques are used. In some specific embodiments, a deterministic mechanism is used to break graphs into connected subgraphs where any edge representing hops greater than a threshold value, T, is automatically removed from the original graph.

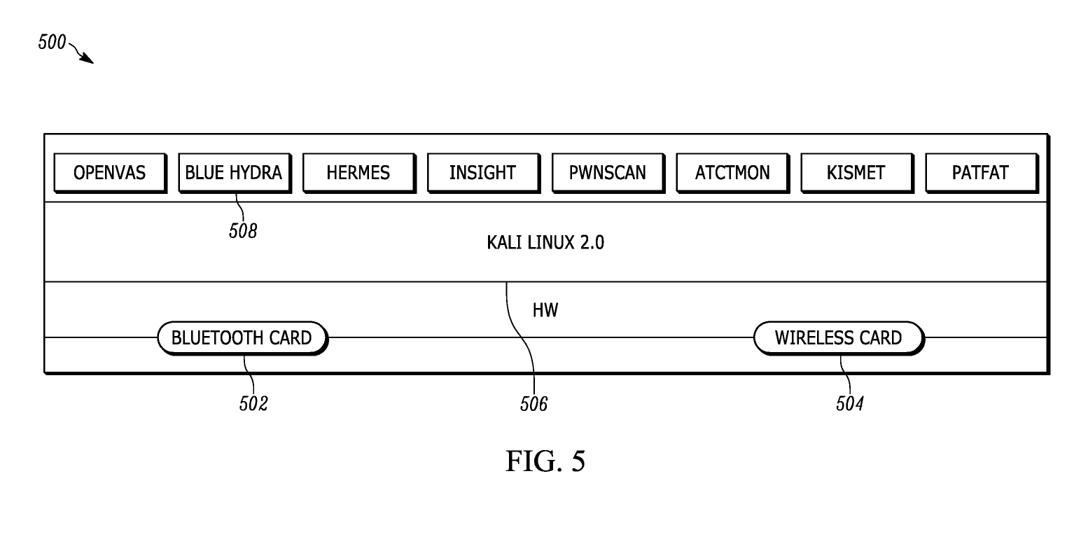

FIG. 5 illustrates a software and hardware module block diagram of an embodiment of a security appliance 500 according to the present teaching. The security appliance 500 comprises hardware and software that perform networking and communication functions and sensing functions of the network to which it is attach. As shown in FIG. 5, the platform hardware on a trusted device includes a Bluetooth card 502, wired interface (not shown) and wireless network interface cards 504. The trusted nodes establish one or more connections to the onsite network, which can be a LAN or other private network, using the network interfaces 502, 504. The trusted nodes can run, for example, a Linux software operating system 506. In some embodiments, the various hardware and software modules provides more than one hundred OSS-based penetration testing tools, such as Metasploit, SET, Kismet, Aircrack-NG, SSLstrip, Nmap, Hydra, W3af, Scapy, Ettercap, and Bluetooth/VoIP/IPv6 tools.

Various software application modules 508 execute on the Linux operating system 506, allowing the security appliance to perform various functions. The various functions performed by the software application module include, for example, detection and viewing of trusted and untrusted devices on the network. This function continuously discovers in real time all wired, WiFi, and Bluetooth devices in the vicinity of a network domain or domains. Another function is identifying, fingerprinting, auditing, and logging devices in a network domain or domains. This function provides a comprehensive list of devices, behaviors and/or historical information that can help recognize noncompliant, misconfigured, unauthorized or threatening devices. Another function performed by the software application modules is monitoring and alerting based on established network security policies using a rules library. This function provides customizable continuous device monitoring to determine changes, misconfigurations, and/or security policy violations, and then provides alerts back to a management system regarding those changes. Another function performed by the software application module is to respond and report based on security policies. This function tracks and disables devices on a network domain or domains. Another function is identification of rogue devices on a network domain or domains. The rogue devices include wireless keyloggers, rogue (evil) access points, WiFi and Bluetooth hacking gear, hacking and penetration testing drop boxes, mobile hacking gear, and wireless card skimmers.

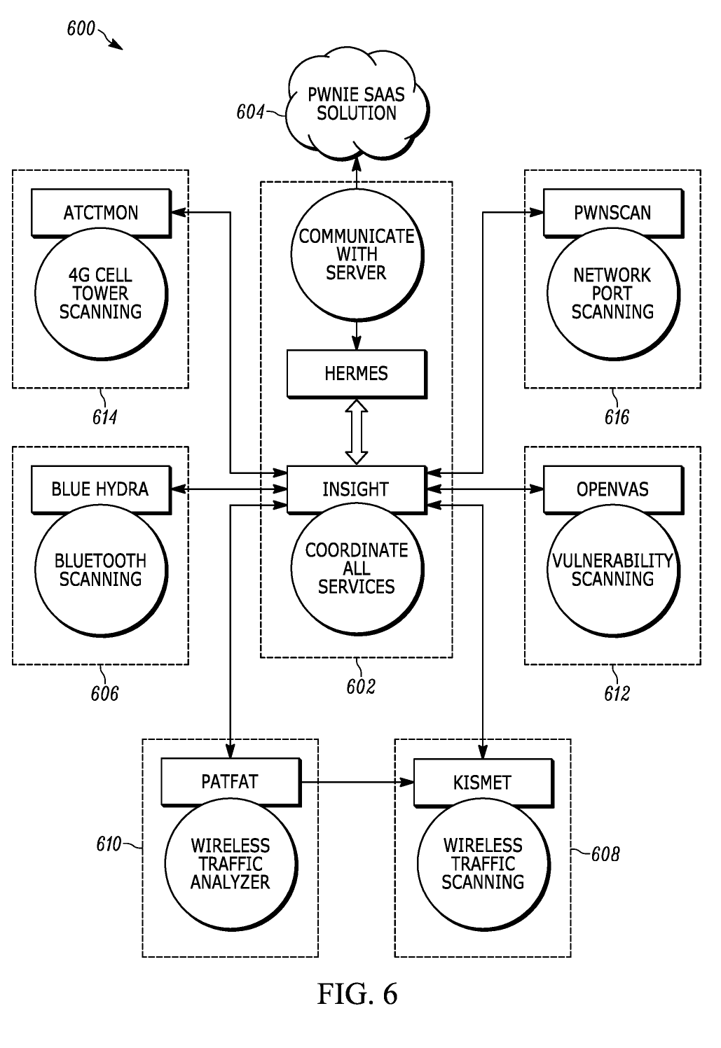

FIG. 6 illustrates an ecosystem of services 600 using the method of managing devices that monitor and protect a distributed network of the present teaching. FIG. 6 illustrates how the various application modules connect to perform various functions or tasks. In some embodiments, the software that implements the method of the present teaching in the trusted node resides in the communication and coordination module 602. The software that implements the method of the present teaching in the endpoint server resides in a module at an offsite location or in the cloud 604. In some embodiments, an endpoint server in the cloud 604 assigns domains to various trusted nodes, and these domain assignments are communicated to the trusted nodes using the communication and coordination modules 602 in each trusted node. The domain assignments are then used by the communication and coordination modules 602 to control and manage various other functions performed by the trusted node, including Bluetooth scanning 606, wireless traffic scanning 608, wireless traffic analysis 610, vulnerability scanning 612, 4G cell tower scanning 614, and network port scanning 616. The communication and coordination module 602 may also be used to refine the local network graphs for communication back to the endpoint server. The communication between the communication and coordination module 602 and the endpoint server in the cloud 604, may reside on a covert and encrypted channel that is established by the trusted node to the endpoint server using an encrypted back door that is part of the communication and coordination module 602.

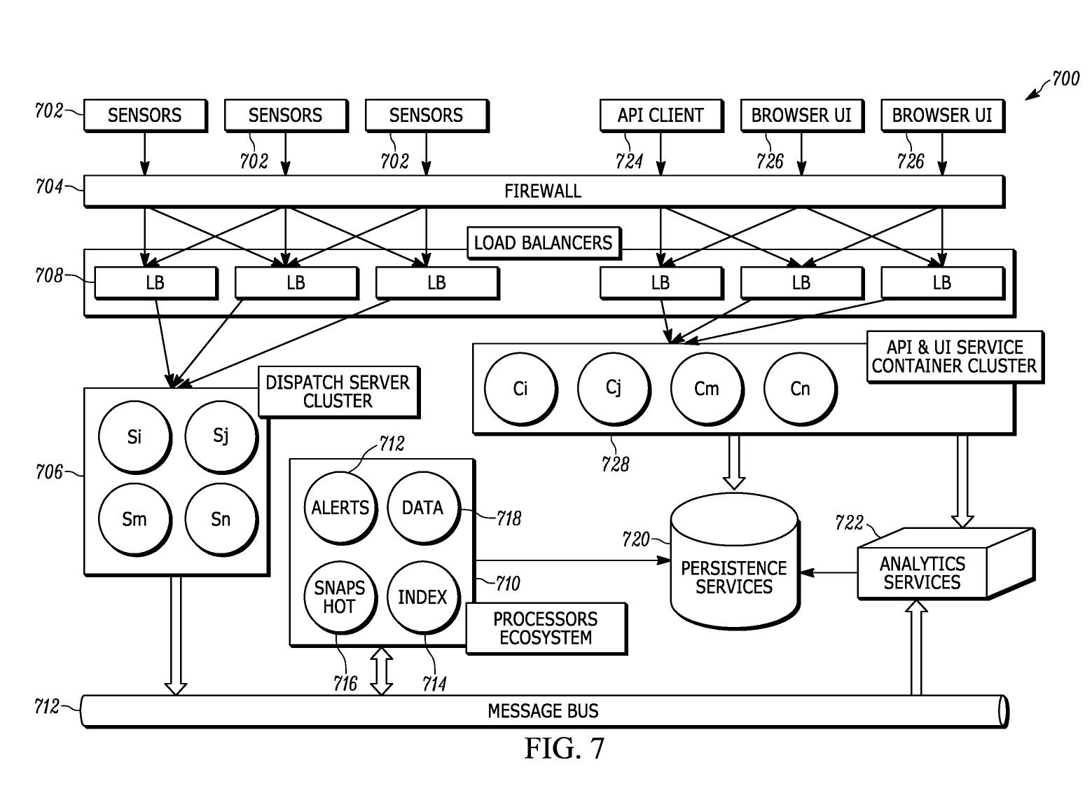

FIG. 7 illustrates a block diagram of an apparatus 700 comprising hardware and software modules that implement the method of managing devices that monitor and protect a distributed network of the present teaching. Trusted devices, or sensors 702, are located behind a firewall 704 in a network domain. The sensors 702 initiate a connection to an endpoint server. In this embodiment, the endpoint server is a cluster of servers called the dispatch server cluster 706. Load balancers 708 act as a reverse proxy and also distribute the communications from the sensors 702 across a number of servers in the dispatch server cluster 706. The dispatch server cluster 706 connects to a processor ecosystem 710 via a message bus 712. The processor ecosystem 710 provides alerts 712, indexing 714, snapshots 716 and data 718. The functions provided by the processor ecosystem 710 are informed by data provided about the network domain behind the firewall 704 by the sensors 702 via the dispatch server cluster 706. Data provided about the network domain behind the firewall 704 provided by the sensors 702 thus contributes to persistence services 720, and analytics services 722. These services are accessed by users or clients that own the network domain via an API client 724, and various browser UI 726 that connect to an API and UI service container cluster 728 that is connected to the persistence services 720 and analytics services 722. In this way, the users or clients advantageously probe and monitor the status and security of their network domain.

Thus, the apparatus 700 of FIG. 7 provides simple and scalable asset discovery, management, vulnerability scanning and penetration testing solutions for remote sites and all wired and wireless networks and devices in a client network domain. The apparatus and method of the present teaching may also be extended to clients and users with multiple network domains.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A method of managing devices that monitor and protect a distributed network, the method comprising:
a) obtaining a peer topology and master-selection rules at each of a plurality of peer devices;
b) selecting a master device at each of the plurality of peer devices using the peer topology and master-selection rules;
c) receiving at the master device management information and operation information from a server;
d) obtaining at the master device updated master-selection rules and updated peer topology;
e) sending from the master device to each of the plurality of peer devices tasking and task updates determined from the operation information, upgrades determined from the management information, the updated master-selection rules and the updated peer topology;
f) generating at the plurality of peer devices reports based on the tasking;
g) receiving at the master device the plurality of reports based on the tasking;
h) generating at the master device a master report based on the plurality of reports based on the tasking and sending the master report to the server; and
i) determining at the plurality of peer devices if the master device is disconnected, and, if so, selecting a new master device from the plurality of peer devices.

2. The method of managing devices that monitor and protect the distributed network of claim 1 wherein the obtaining the peer topology and master-selection rules comprises receiving the peer topology and master-selection rules from the server.

3. The method of managing devices that monitor and protect the distributed network of claim 1 wherein the obtaining the peer topology and master-selection rules comprises determining the peer topology at each of the plurality of peer devices.

4. The method of managing devices that monitor and protect the distributed network of claim 1 wherein the obtaining the peer topology and master-selection rules comprises obtaining master-selection rules from memory.

5. The method of managing devices that monitor and protect the distributed network of claim 1 wherein the obtaining at the master device updated master-selection rules and updated peer topology comprises receiving the updated master-selection rules and updated peer topology from the server.

6. The method of managing devices that monitor and protect the distributed network of claim 1 wherein the obtaining at the master device updated master-selection rules and updated peer topology comprises determining the updated master-selection rules and updated peer topology at the master device.

7. The method of managing devices that monitor and protect the distributed network of claim 1 further comprising:
a) determining at the server a peer device location for each of the plurality of peer devices;
b) determining at the server a priority schema using the determined peer device locations;
c) generating at the server the peer topology using the priority schema; and
d) generating at the server the master-selection rules based on the peer topology.

8. The method of managing devices that monitor and protect the distributed network of claim 7 further comprising iterating steps a) through c) of claim 7 to heuristically improve the peer topology.

9. The method of managing devices that monitor and protect the distributed network of claim 7 further comprising receiving an update from the master device at the server and generating the updated master-selection rules at the server based on the update.

10. The method of managing devices that monitor and protect the distributed network of claim 7 further comprising receiving an update from the master device at the server and generating the updated peer topology at the server based on the update.

11. The method of managing devices that monitor and protect the distributed network of claim 1 wherein the plurality of peer devices comprise a plurality of security appliances.

12. The method of managing devices that monitor and protect the distributed network of claim 1 wherein the tasking comprises monitoring the distributed network.

13. The method of managing devices that monitor and protect the distributed network of claim 1 wherein the tasking comprises detecting attacks on the distributed network.

14. The method of managing devices that monitor and protect the distributed network of claim 1 wherein the tasking comprises identifying rogue devices in the distributed network.

15. The method of managing devices that monitor and protect the distributed network of claim 1 wherein the tasking comprises simulating an attack on the distributed network.

16. The method of managing devices that monitor and protect the distributed network of claim 1 wherein the upgrades comprise a binary library upgrade.

17. The method of managing devices that monitor and protect the distributed network of claim 1 wherein the task updates comprise an attack signature.

18. The method of managing devices that monitor and protect the distributed network of claim 1 wherein the task updates comprise a target of a scan.

19. The method of managing devices that monitor and protect the distributed network of claim 1 wherein the task updates comprise a frequency of a scan.

20. The method of managing devices that monitor and protect the distributed network of claim 1 further comprising caching the master report at the master device.

21. A method of managing devices that monitor and protect a distributed network, the method comprising:
a) determining at a server a peer device location for each of a plurality of peer devices;
b) determining at the server a priority schema using the determined peer device locations;
c) determining at the server a peer device topology for the plurality of peer devices using the priority schema;
d) sending to the plurality of peer devices the peer device topology and master selection rules;
e) receiving from a master node a master report and a configuration report;
f) generating at the server an updated peer device topology and an updated master selection rules based on the configuration report;
g) sending the updated peer device topology and the updated master selection rules to the master device; and
h) receiving from a new master device a new master report and a new configuration report.

22. The method of managing devices that monitor and protect the distributed network of claim 21 wherein the determining at the server the peer device topology for the plurality of peer devices comprises determining a virtual ring topology.

23. The method of managing devices that monitor and protect the distributed network of claim 21 further comprising iterating steps d) through g) of claim 21 to heuristically improve the updated peer topology.

24. The method of managing devices that monitor and protect the distributed network of claim 21 further comprising iterating steps d) through g) of claim 21 to heuristically improve the updated master selection rules.

25. The method of managing devices that monitor and protect the distributed network of claim 21 further comprising:
a) receiving at the master node operation information and management information from the server;
b) sending from the master device to each of the plurality of peer devices tasking and task updates determined from the operation information, upgrades determined from the management information, the updated master-selection rules and the updated peer topology;
c) generating at the plurality of peer devices reports based on the tasking;
d) receiving at the master device the plurality of reports based on the tasking;
e) generating at the master device the master report based on the plurality of reports based on the tasking and the configuration report based on a configuration of the plurality of peer devices and sending the master report and the configuration report to the server; and
f) determining at the plurality of peer devices if the master device is disconnected, and, if so, selecting the new master device from the plurality of peer devices.

26. The method of managing devices that monitor and protect a distributed network of claim 25 wherein tasking comprises monitoring the distributed network.

27. The method of managing devices that monitor and protect a distributed network of claim 25 wherein tasking comprises detecting attacks on the distributed network.

28. The method of managing devices that monitor and protect a distributed network of claim 25 wherein tasking comprises identifying rogue devices in the distributed network.

29. The method of managing devices that monitor and protect a distributed network of claim 25 wherein tasking comprises simulating an attack on the distributed network.

30. The method of managing devices that monitor and protect a distributed network of claim 25 wherein task updates comprises a frequency of a scan.

31. The method of managing devices that monitor and protect a distributed network of claim 25 wherein task updates comprises a target of a scan.

32. The method of managing devices that monitor and protect a distributed network of claim 25 wherein task updates comprises an attack signature.

33. The method of managing devices that monitor and protect a distributed network of claim 21 further comprising caching the master report at the master device.

34. The method of managing devices that monitor and protect a distributed network of claim 21 wherein the plurality of peer devices comprise a plurality of security appliances.
